(19) United States
(12) Patent Application Publication
(10) Pub. No.: US 2024/0376318 A1
(43) Pub. Date: Nov. 14, 2024

(54) METHOD FOR PRODUCING A GRANULATED METAL OXIDE POWDER AND CORRESPONDING GRANULATED METAL OXIDE POWDER

(71) Applicant: FRAMATOME, COURBEVOIE (FR)

(72) Inventor: Stéphane Lagarde, GRENOBLE (FR)

(21) Appl. No.: 18/692,733

(22) PCT Filed: Sep. 15, 2022
(86) PCT No.: PCT/EP2022/075698

§ 371 Date: Mar. 15, 2024

(30) Foreign Application Priority Data
Sep. 17, 2021 (FR) FR2109781

(51) Int. Cl. C09C 3/00; C01G 25/02; C01G 27/02; C09C 3/04; C09C 3/10

(52) U.S. Cl. CPC C09C 3/006; C01G 25/02; C01G 27/02; C09C 3/043; C09C 3/10; C01P 2002/60; C01P 2004/61

(57) ABSTRACT

A method for producing a granulated metal oxide powder and corresponding granulated metal oxide powder includes obtaining an initial metal oxide powder, consisting of particles of a metal oxide, by hydrolysing a chloride of the metal and forming a suspension containing the initial metal oxide powder and an organic binder suspended in a suspension medium. The method also includes drying the suspension so as to obtain granulated metal oxide powder, consisting of grains formed by agglomerates of particles of the initial metal oxide powder.

### CROSS-REFERENCE TO RELATED APPLICATIONS

This application is the U.S. National Phase of PCT Appl. No. PCT/EP2022/075698 filed Sep. 15, 2022, which claims priority to FR 21 09781, filed Sep. 17, 2021, the entire disclosures of which are incorporated by reference herein.

### TECHNICAL FIELD

The present disclosure relates to the field of producing a metal oxide powder.

### BACKGROUND

The metal oxide powder is e.g. zirconium dioxide powder, hafnium dioxide powder, titanium oxide powder, niobium oxide powder or aluminum oxide powder.

### SUMMARY

Such metal oxide powders can be used e.g. for the manufacture of ceramics obtained by isostatic pressing and sintering.

Such metal oxide powders can be used in any type of application, e.g. in nuclear or medical applications, more particularly for medical prostheses, targets for the production of thin films by cathodic sputtering or for the manufacture of parts by additive manufacturing.

Zirconium dioxide powder and hafnium dioxide powder are used e.g. in the nuclear field, for the manufacture of mechanical parts.

One of the aims of the present disclosure is to propose a method for producing a metal oxide powder for obtaining a powder having properties facilitating the use thereof for the manufacture of metal parts.

To this end, the present disclosure proposes a method for producing a granulated metal oxide powder, more particularly a granulated zirconium oxide powder or a granulated hafnium oxide powder, the production method comprising the following steps:
obtaining an initial metal oxide powder, composed of particles of a metal oxide, by hydrolysis of a chloride of said metal;
forming a suspension containing the initial metal oxide powder and an organic binder suspended in a suspension medium;
drying the suspension so as to obtain the granulated metal oxide powder, consisting of grains formed by agglomerates of particles of the initial metal oxide powder.

The initial metal oxide powder obtained by hydrolysis of a metal chloride has particles with a small median diameter, with desired properties, e.g. a particular crystal structure of the metal oxide.

The forming of the suspension and the drying, preferentially by spray drying, serve to obtain a granulated metal oxide powder formed of grains having a median diameter strictly greater than the diameter of the particles of the initial metal oxide powder, while preserving other particle features of the granulated metal oxide powder, such as the crystal structure of the metal oxide, the chemical purity of the metal oxide or the specific surface area of the granulated metal oxide powder.

Thereby, the granulated metal oxide powder has different flow characteristics than the original metal oxide powder, allowing the granulated metal oxide powder to be used in different manufacturing methods.

According to particular embodiments, the production method comprises one or a plurality of the following optional features, taken individually or in all technically possible combinations:
the hydrolysis of the metal chloride is carried out from the metal chloride in vapor phase and/or water in vapor phase;
the drying step is carried out by atomization of the suspension;
the suspension medium is water;
the organic binder is chosen from polyethylene glycol (PEG), polyvinyl alcohol (PVA), starch and stearic acid;
the production method comprises a step of calcination of the granulated metal oxide powder;
the median particle diameter of the initial metal oxide powder is less than or equal to 1 μm;
the median grain diameter of the granulated metal oxide powder is greater than or equal to 5 μm, more particularly greater than or equal to 10 μm, even more particularly greater than or equal to 15 μm;
the granulated metal oxide powder has a compressibility less than or equal to 25%, more particularly a compressibility less than or equal to 20%;
the metal is zirconium, the granulated metal oxide powder obtained being a granulated zirconium dioxide powder;
the metal is hafnium, the metal oxide powder obtained being a granulated hafnium dioxide powder.

The present disclosure further relates to a granulated metal oxide powder, more particularly a granulated zirconium oxide powder or a granulated hafnium oxide powder, obtained or which can be obtained by a method as defined hereinabove.

In one embodiment, the granulated metal oxide powder comprises grains formed of agglomerates of metal oxide particles, the median diameter of the grains being greater than or equal to 5 μm, more particularly greater than or equal to 10 μm, the median diameter of the grains being less than or equal to 70 μm, more particularly less than or equal to 60 μm and/or 90% of the grains having a diameter less than or equal to 115 μm.

In one embodiment, the metal is zirconium or hafnium.

### BRIEF SUMMARY OF THE DRAWINGS

The present disclosure and the advantages of the present disclosure will better understood upon reading the following description, given only as a non-limiting example, and made with reference to the enclosed drawings, wherein:

FIG. 1 is a diagram illustrating the steps of the method for producing granulated; metal oxide powder;

FIG. 2 is a block diagram illustrating an installation for the implementation of the method for producing granulated metal powder.

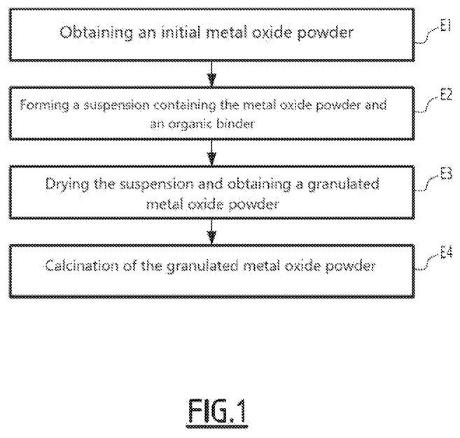

As shown in FIG. 1, the production method comprises:
a step E1 of obtaining an initial metal oxide powder, composed of particles of an oxide of a metal, by hydrolysis of a chloride of said metal,
a step E2 of forming a suspension containing the initial metal oxide powder and an organic binder suspended in a suspension medium,
a step E3 of drying the suspension so as to obtain the granulated metal oxide powder, and,
optionally, a step E4 of calcination of the granulated metal oxide powder.

### DETAILED DESCRIPTION

During step E1, the metal chloride is placed in the presence of water with which same reacts chemically in order to give both the oxide of the said metal and hydrochloric acid.

The hydrolysis of metal chloride is carried out with the metal chloride in the vapor phase (vapor state) and water in the vapor phase (vapor state).

Thereby, in a particular example of embodiment, the hydrolysis of the metal chloride is preferentially carried out by bringing the metal chloride vapor into contact with water vapor.

After the hydrolysis, the initial metal oxide powder is obtained, which consists of particles of the metal oxide.

Advantageously, the hydrolysis is carried out so as to obtain an initial “submicron” metal oxide powder, i.e. the particles of which have a median diameter less than or equal to 1 μm.

The median particle diameter of a powder is measured e.g. by a technique of gravity decanting in water and concentration measurement over time by attenuation of a light beam (e.g. using a SEDIGRAPH measuring device) or by sedimentation in a centrifugal field with concentration measurement over time of a blue or red laser beam (e.g. using a LUMISIZER measuring instrument).

Preferentially, the hydrolysis is carried out at a temperature between 300° C. and 700° C., with a ratio between the water flow and the metal chloride flow at least equal to the stoichiometric ratio and/or a residence time in the hydrolysis reactor which is comprised between 5 seconds and 60 seconds, preferentially between 10 seconds and 30 seconds.

The metal oxide of the metal oxide powder preferentially has a monoclinic and tetragonal (or quadratic) crystal morphology, where the ratio between the two crystal structures may vary depending on the parameters used for the implementation of the method.

The metal is more particularly zirconium, in which case the initial metal oxide powder is zirconium oxide powder, more particularly a zirconium dioxide (or zirconia) powder, or hafnium, in which case the initial metal oxide powder is a hafnium oxide powder, more particularly a powder of hafnium dioxide (or hafnia).

During step E2, a suspension is formed containing the initial metal oxide powder and an organic binder suspended in a suspension medium.

The suspension medium is e.g. water.

The organic binder is e.g. chosen from polyethylene glycol (PEG), polyvinyl alcohol (PVA), starch and stearic acid. Such organic binders can be removed subsequently, e.g. by calcination.

Advantageously, the suspension comprises from 20 to 70% by weight of initial metal oxide powder and the ratio of the weight of organic binder to the weight of metal oxide powder is comprised between 1 and 5%.

The suspension is formed e.g. by mixing the metal oxide powder with a solution containing the organic binder and the suspension medium.

In a particular example of embodiment, the suspension medium is water. The suspension obtained at the end of step E2 is a solution of the organic binder in water containing the metal oxide powder suspended in solution.

During step E3, the suspension obtained at the end of step E2 is dried so as to obtain the granulated metal oxide powder.

Drying is carried out in a drying system or dryer.

Drying is carried out so as to remove the suspension medium, more particularly so as to evaporate the suspension medium. More particularly, when the suspension medium is water, drying is carried out in such a way that the water evaporates.

The presence of the organic binder in the suspension leads to obtaining a granulation of the metal oxide powder, i.e. an agglomeration of the particles of the initial metal oxide powder so as to obtain grains larger than the particles.

Drying is carried out e.g. by atomizing the suspension.

The atomization of the suspension involves spraying the suspension in the form of droplets into a stream of hot gas, more particularly into a stream of hot air.

The above serve to evaporate the suspension medium and to collect the granulated metal oxide powder. Spraying is carried out e.g. in an atomization chamber.

The atomization of the suspension preferentially comprises the separation of the granulated metal oxide powder and of the gaseous stream consisting of the hot air and the evaporated suspension medium.

The above allows the granulated metal oxide powder to be collected. The separation is carried out in a separator, e.g. in a cyclone effect separator.

In one example of embodiment, the median grain diameter of the granulated metal oxide powder is greater than or equal to 5 μm, more particularly greater than or equal to 10 μm, the median grain diameter of the granulated metal oxide powder being less than or equal to 70 μm, more particularly less than or equal to 60 μm, and/or at least 90% of the grains of the granulated metal oxide powder having a grain diameter less than or equal to 115 μm.

In particle size distribution, DXX denotes the diameter such that at least XX % of the grains of the powder have a diameter less than or equal to DXX. It is common to measure the diameter D10, the diameter D50, also called the median diameter, and the diameter D90.

The deviation E of the particle size distribution of a powder can be defined by the following formula: E=(D90−D10)/D50.

The metal oxide powder may optionally contain residues of hydrogen, of chlorine and of carbon resulting from the different steps carried out beforehand.

In the case of drying by atomization, spraying is carried out in the dryer using at least one sprayer or spraying member, preferentially chosen from a sprayer nozzle, a bi-fluid nozzle or a spray turbine. Preferentially, the outlet temperature of the dryer is adjusted preferentially between 80° C. and 150° C. for obtaining a sufficiently low humidity.

Preferentially, the inlet temperature of the dryer is adjusted according to the flow rate of water to be evaporated, preferentially between 150° C. and 300° C.

In the case of drying by spraying, the spraying conditions depend on the rheology of the suspension and of the type of sprayer (sprayer nozzle, bi-fluid nozzle, spray turbine).

The optional implementation of the calcination step E4 serves to eliminate such residues at least in part, and possibly completely.

Calcination consists in bringing the powder to a high temperature in a calcination furnace. The calcination step can also change the crystal structure of the metal oxide powder.

The calcination step also serves to control the morphology of the grains and the particle size distribution, which is narrower (smaller grain size dispersion).

The calcination step is preferentially carried out at a temperature comprised between 60° and 1300° C. and/or for a length of time comprised between 1 h and 3 h, more particularly when the metal involved is hafnium.

Optionally, the production method comprises a screening step carried out after the drying step E3. If a calcination step E4 is planned, the screening step is carried out before or after the calcination step E4. Such a screening step serves to remove the largest grains.

By means of the production method, the grains of the granulated metal oxide powder are mainly formed of agglomerates of particles of the initial metal oxide powder, bound together by the organic binder.

As a result therefrom, the grains of the granulated metal oxide powder and the particles of the initial metal oxide powder have, in particular, the same chemical purity and crystal structure as the metal oxide, the granulated metal oxide powder having a larger particle size than the initial metal oxide powder, which changes properties of the granulated metal oxide powder with respect to the initial metal oxide powder.

The granulated metal oxide powder has different characteristics than the initial (non-granulated) metal oxide powder, in particular because the grain size of the granulated metal oxide powder is larger than the particle size of the initial metal oxide powder.

The granulated metal oxide powder has more particularly an apparent density and flow properties different from same of the initial metal oxide powder obtained at the end of step E1, i.e. at the end of the hydrolysis.

More particularly, the granulated metal oxide powder has a compressibility (or Carr index) greater than same of the non-granulated initial metal oxide powder resulting from step E1, i.e. at the end of the hydrolysis.

The compressibility (or Carr index) of a powder is the percentage of change between the tapped density of the powder and the untapped density of the powder with respect to the tapped density of the powder.

The untapped density and the tapped density of a powder is measured in a known way, e.g. using a DENSITAP apparatus.

The lower the compressibility, the higher the flowability.

Preferentially, the granulated metal oxide powder has a compressibility less than or equal to 25%, more particularly a compressibility less than or equal to 20%.

In a first example, a zirconium dioxide powder (or zirconia powder) was obtained according to the production method, using the parameters indicated hereinafter.

The hydrolysis was carried out in a hydrolysis reactor with an hourly mass flow-rate of zirconium chloride (ZrCl₄) of 19 kg/h, an hourly mass flow-rate of water vapor of 3 kg/h and at a temperature of 500° C.

The suspension was made by mixing the zirconia powder obtained at the end of the hydrolysis with an aqueous polyethylene glycol (PEG) solution, in such a way that the suspension contains 60% by weight of zirconia powder and 40% by weight of aqueous solution.

In such an aqueous solution, the suspension medium is water and the organic binder is PEG.

The concentration of PEG in the aqueous solution is chosen such that, in the suspension obtained, the ratio between the weight of PEG and the weight of zirconia powder is 3%.

Drying was carried out by atomization in a turbine atomizer with a diameter of 17.78 cm (7 inches) and a dryer with a diameter of 2.5 m, with an inlet temperature of 300° C. and an outlet temperature of 130° C. The residual moisture content of the granulated zirconium dioxide powder after drying by atomization was less than 0.1%.

The method was implemented on a pilot installation and on an industrial installation, the latter allowing higher particle sizes to be attained.

The initial zirconium dioxide powder and the granulated zirconium dioxide powder were analyzed in order to verify that the initial zirconium dioxide powder particles and the grains of the granulated zirconium dioxide powder have substantially the same chemical purity and the same crystalline structure in the absence of or prior to the calcination step.

The median diameter, untapped density and tapped density of each of the initial zirconium dioxide powder and the granulated zirconium dioxide powder have been measured, and the compressibilities of the initial zirconium dioxide powder and of the granulated zirconium dioxide powder were calculated.

Table 1 hereinbelow shows the results.

| | Median | Untapped | Tapped | Compressibility |
|---|---|---|---|---|
| Zirconia powder | diameter (μm) | density | density | (%) |
| Before | 0.3 | 0.43 | 0.62 | 30 |
| granulation | | | | |
| After granulation | 15 | 0.96 | 1.18 | 19 |
| on a pilot | | | | |
| installation | | | | |
| After granulation | 30 | 1.06 | 1.29 | 18 |
| on an industrial | | | | |
| installation | | | | |

It emerges therefrom that the granulated zirconium dioxide powder has a lower compressibility than the compressibility of the initial zirconium dioxide powder, and hence a higher flowability.

Furthermore, for a granulated zirconia powder dried by atomization, the production on an industrial installation leads to obtaining a higher particle size than on a pilot installation.

In a second example, a hafnium dioxide powder (or hafnia powder) was obtained according to the production method, using the following parameters

The hydrolysis was carried out in a hydrolysis reactor with an hourly mass flow-rate of hafnium chloride (HfCl₄) of 26 kg/h, an hourly mass flow-rate of water vapor of 3 kg/h and at a temperature of 500° C.

The suspension was made by mixing the hafnia powder obtained at the end of the hydrolysis with an aqueous solution of water and polyethylene glycol (PEG) containing by 60% by weight of hafnia powder and 40% by weight of aqueous solution.

The concentration of PEG in the aqueous solution is chosen such that, in the suspension obtained, the ratio between the weight of PEG and the weight of hafnia powder is 3%.

Drying was carried out by atomization with an inlet temperature of 300° C. and an outlet temperature of 120° C. The residual moisture content of the granulated zirconium dioxide powder after drying by atomization was less than 0.1%.

The method was implemented on a pilot installation.

The initial hafnium dioxide powder and the granulated hafnium dioxide powder were analyzed in order to verify that the hafnium dioxide grains have substantially the same chemical purity, the same crystal structure and the same size.

The median diameter, the untapped density and the tapped density of each of the initial hafnium dioxide powder and the granulated hafnium dioxide powder have been measured, and the compressibilities of the initial hafnium dioxide powder and of the granulated hafnium dioxide powder were calculated.

Table 2 hereinbelow shows the results.

| | Median | Untapped | Tapped | Compressibility |
|---|---|---|---|---|
| Hafnia powder | diameter (μm) | density | density | (%) |
| Before | 0.3 | 0.68 | 0.97 | 30 |
| granulation | | | | |
| After | 15 | 1.25 | 1.57 | 20 |
| granulation | | | | |

The result is that granulated hafnium dioxide powder has a lower compressibility than the initial hafnium dioxide powder, and hence a higher flowability.

Preferentially, the granulated metal oxide powder has a particle size distribution difference E comprised between 0.4 and 0.6, e.g. on the order of 0.5.

The granulated metal oxide powder, and more particularly the granulated zirconium dioxide powder or the granulated hafnium oxide powder, has a microstructure defined in particular by the degree of monoclinic crystalline phase, the degree of quadratic crystalline phase, the size of crystals in monoclinic phase and the size of crystals in quadratic phase.

The percentage of monoclinic crystalline phase, the percentage of quadratic crystalline phase, the sizes of monoclinic crystalline phase and the sizes of quadratic crystalline phase can be determined by analyzing X-ray diffraction patterns.

Preferentially, the granulated metal oxide powder, and more particularly the granulated zirconium dioxide powder or the granulated hafnium oxide powder, has:
a percentage of monoclinic crystalline phase comprised between 0% and 50%,
a percentage of quadratic crystalline phase comprised between 50% and 100%,
a size of crystal structures in the monoclinic crystalline phase is comprised between 10 and 20 nm, more particularly between 14 and 16 nm and/or
a size of crystal structures in the quadratic crystalline phase is comprised between 10 and 20 nm, more particularly between 13 and 15 nm.

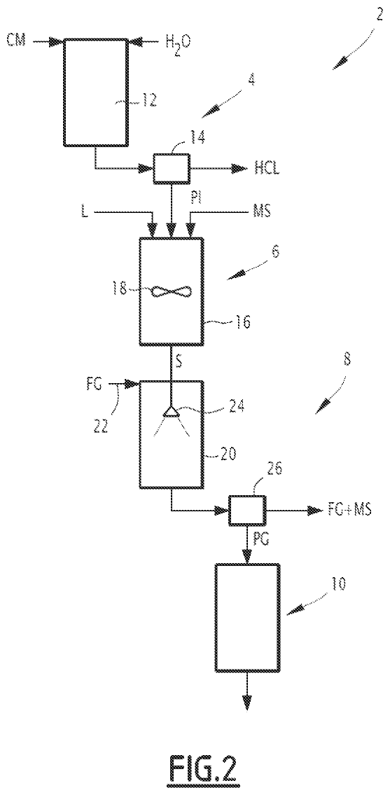

As illustrated in FIG. 2, an installation 2 for implementing the production method comprises e.g. a hydrolysis reactor 4, a mixing reactor 6, a dryer 8 and, optionally, a calcination furnace 10.

The hydrolysis step E1 is carried out in the hydrolysis reactor 4. The hydrolysis reactor 4 comprises a hydrolysis chamber 12 which receives the metal chloride CM and the water H2O, preferentially in the form of water vapor.

The hydrolysis reactor 4 supplies both the initial metal oxide powder PI and the hydrochloric acid HCl.

The hydrolysis reactor 4 is e.g. provided, at an outlet of the hydrolysis chamber 12, with a separator 14, more particularly a cyclone effect separator, for separating the initial metal oxide powder from the hydrochloric acid.

As an alternative to or in addition to the separator 14, the hydrolysis reactor is equipped with a bag filter (not shown) for separating the initial metal oxide powder from the hydrochloric acid.

The suspension step E2 is carried out e.g. in the mixing reactor 6. The mixing reactor 6 comprises e.g. a mixing chamber 16 for receiving the elements to be mixed, namely the suspension medium MS, the organic binder L and the initial metal oxide powder PI, the mixing being carried out in the mixing chamber 16.

The mixing reactor 6 provides the suspension S comprising the organic binder L and the initial metal oxide powder PI suspended in the suspension medium MS.

The mixing reactor 6 optionally comprises a stirring system 18 configured to stir the contents of the mixing chamber 16.

The drying step E3 is implemented e.g. by the dryer 8.

The dryer 8 is configured e.g. to carry out drying by atomization.

The dryer 8 comprises an atomization chamber 20 having a hot gas inlet 22 for injecting a hot gas flow FG into the atomization chamber 20, more particularly a hot air flow, and a sprayer member 24 for spraying the suspension S into the hot gas flow.

The sprayer member 24 is e.g. a sprayer nozzle 24. Alternatively, a bi-fluid nozzle or a spray turbine is used.

The dryer 8 preferentially comprises a separator 26 arranged at an outlet of the atomization chamber 20 for separating, on the one hand, the granulated metal oxide powder PG resulting from the drying and, on the other hand, the gas stream containing the hot gas stream FG and the evaporated suspension medium MS. The separation 26 is e.g. a cyclone effect separator or a filter, more particularly a bag filter.

The optional calcination step E4 is carried out in the calcination furnace 10, which receives and heats the granulated metal oxide powder PG obtained at the end of step E3.

The calcination furnace 10 is e.g. a rotary furnace or a tunnel furnace.

When a screening step (optional) is carried out, after drying (where appropriate, before or after calcination) the installation comprises a screening system (not shown).

By means of the present disclosure, it is possible to obtain a granulated metal oxide powder which preserves some of the characteristics of the initial non-granulated metal oxide powder obtained by hydrolysis of a chloride of the metal considered, more particularly the crystal structure of the metal oxide, the chemical purity of the metal oxide and the specific surface area of the powder, while modifying other characteristics, more particularly by decreasing the compressibility of the granulated metal oxide powder compared to the initial (non-granulated) metal oxide powder.

Maintaining certain characteristics while improving other characteristics, more particularly compressibility, allows the metal oxide powder to be used for the manufacture of the same parts, but with different manufacturing methods, more particularly manufacturing methods requiring good flowability of the metal oxide powder.

For example, a good flowability of the metal oxide powder is favorable to the use thereof or the production of mechanical parts by additive manufacturing.

The characteristics of the particle size distribution (more particularly median diameter D50, deviation E of particle size distribution, etc.) and crystalline characteristics (more particularly degree of monoclinic crystalline phase, degree of quadratic crystalline phase, size of crystal structures, etc.) of the granulated metal oxide powder have an influence on the use of the granulated metal oxide powder, more particularly on the possibility of the use thereof in various manufacturing methods.

Drying by atomization is the preferred method because such drying makes it easier to handle the metal oxide powder, which is very fine and has a very low density (typically a density of less than 300 kg/m3) because same is integrated into a liquid suspension.

Drying by atomization serves to generate regular agglomerates (close to spherical grains) and a narrow particle size distribution that is easily adjustable by adjusting the parameters of drying by atomization, such as the speed of rotation of the turbine, if the drying by atomization is carried out using a turbine, or the inlet pressure of a sprayer nozzle, if the drying by atomization is carried out using a sprayer nozzle.

Other granulation methods, such as a granulation method using a fluidized bed or a mixer, would raise problems with the non-granulated metal oxide powder, such a non-granulated metal oxide powder being difficult to “fluidize” and/or requiring very large volumes of equipment because of the low density thereof.

Such granulation methods can generate more irregular agglomerates and a more spread particle size distribution than is obtained with the method of drying by atomization.

What is claimed is:

1-18. (canceled)

19. A method for producing a granulated metal oxide powder or a granulated hafnium oxide powder comprising the following steps:
obtaining an initial metal oxide powder, composed of particles of a metal oxide, by hydrolysis of a chloride of said metal;
forming a suspension containing the initial metal oxide powder and an organic binder suspended in a suspension medium; and
drying the suspension to obtain a granulated metal oxide powder, consisting of grains consisting of agglomerates of particles of the initial metal oxide powder,
the hydrolysis of the chloride of said metal being carried out from the chloride of said metal in a vapor phase and/or water in a vapor phase.

20. The production method according to claim 19, wherein the drying step is carried out by atomization of the suspension.

21. The production method according to claim 19, wherein the suspension medium is water.

22. The production method according to claim 19, wherein the organic binder is selected from polyethylene glycol (PEG), polyvinyl alcohol (PVA), starch and stearic acid.

23. The production method according to claim 19, further comprising a step of calcination the granulated metal oxide powder.

24. The production method according to claim 19, wherein a median particle diameter of the initial metal oxide powder is less than or equal to 1 μm.

25. The production method according to according to claim 19, wherein a median grain diameter of the granulated metal oxide powder is greater than or equal to 5 μm.

26. The production method according to claim 19, wherein the granulated metal oxide powder has a compressibility less than or equal to 25%.

27. The production method according to claim 19, wherein the metal is zirconium, the granulated metal oxide powder obtained being a granulated zirconium dioxide powder.

28. The production method according to claim 19, wherein the metal is hafnium, the metal oxide powder obtained being a granulated hafnium dioxide powder.

29. The production method according to according to claim 19, wherein a median grain diameter of the granulated metal oxide powder greater than or equal to 10 μm.

30. The production method according to claim 19, wherein the granulated metal oxide powder has a compressibility less than or equal to 20%.

31. A granulated metal oxide powder obtained by the production method according to claim 19.

32. A granulated zirconium oxide powder or granulated hafnium oxide powder, obtained by the production method according to claim 19.

33. A granulated metal oxide powder comprising:
grains consisting of agglomerates of metal oxide particles, a median diameter of the grains being greater than or equal to 5 μm, the median diameter of the grains being less than or equal to 70 μm and/or 90% of grains having a diameter less than or equal to 115 μm, wherein the granulated metal oxide powder has a compressibility less than or equal to 25%.

34. The granulated metal oxide powder according to claim 33, wherein the metal is zirconium or hafnium.

35. The granulated metal oxide powder according to claim 33, wherein the granulated metal oxide powder has a deviation of particle size distribution comprised between 0.4 to 0.6.

36. The granulated metal oxide powder according to claim 33, wherein the granulated metal oxide powder has a compressibility less than or equal to 20%.

37. The granulated metal oxide powder according to claim 33, wherein a percentage of a monoclinic crystalline phase is comprised between 0% and 50% and/or a percentage of a quadratic crystalline phase is comprised between 50% and 100%.

38. The granulated metal oxide powder according to claim 33, wherein a size of crystal structures of a monoclinic crystalline phase is comprised between 10 nm and 20 nm, and/or a size of crystal structures in a quadratic crystalline phase is comprised between 10 nm and 20 nm.
